(19) United States
(12) Patent Application Publication
(10) Pub. No.: US 2004/0176561 A1
(43) Pub. Date: Sep. 9, 2004

(54) Continuous cationic polymerization of siloxanes

(75) Inventor: Benigno A. Janeiro, Burlington, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Gelest, Inc.

(21) Appl. No.: 10/749,442

(22) Filed: Dec. 31, 2003

Related U.S. Application Data
(60) Provisional application No. 60/437,520, filed on Dec. 31, 2002.

(51) Int. Cl. C08G 77/06

(52) U.S. Cl. 528/12

(57) ABSTRACT

A continuous polymerization process produces hydride-functional siloxane and organofunctional siloxane polymers, copolymers and terpolymers. The cationic polymerization takes place in a plug flow catalytic reactor packed with a heterogeneous acid catalyst. The siloxane polymers produced are optically clear, homogeneous and free of catalyst residues.

### CROSS-REFERENCE TO RELATED APPLICATIONS

This application claims the benefit of co-pending U.S. Provisional Patent Application No. 60/437,520, filed Dec. 31, 2002, the disclosure of which is incorporated herein by reference.

### BACKGROUND OF THE INVENTION

This invention relates to a continuous cationic polymerization process for preparing siloxane polymers, copolymers and terpolymers in a catalytic tubular reactor.

Poly-methylhydrosiloxane-dimethylsiloxane copolymers and hydride terminated polydimethylsiloxanes are an essential class of polymers in the silicone industry. They are used as crosslinking agents in two-part addition cure elastomers. In this type of application, the reactivity can be controlled by varying the composition of the methylhydrosiloxane co-monomer which controls the degree of crosslinking. This in turn allows for the mechanical properties of an elastomer to be tailored to a specific application. Addition cured systems produce silicone elastomers for impression materials, filler-free silicone elastomers, which have excellent optical transmission properties and are used as waveguides and encapsulants, and clear silicone gel elastomers which provide environmental, mechanical and dampening protection for microelectronic devices.

Also, poly-methylhydrosiloxane-dimethylsiloxane copolymers are used to produce foamed silicones; they undergo dehydrogenative coupling to impart water repellency to glass, leather, paper, fabric surfaces, and powder; they are used to hydrosilylate unsaturated hydrocarbons to produce alkyl and arylalkyl substituted siloxanes to form organic compatible silicone fluids, allyloxypolyethers which produce surfactants and emulsifiers; they also hydrosilylate unsaturated acrylate, amino and epoxy functional hydrocarbons to produce acrylate, amino and epoxy functional silicones used in UV cure release coatings, fabric softening and adhesion promoters. Also, acrylate functional silicones are quickly becoming an essential class of polymers in the sensor, optoelectronic and microelectronic industries. They are used as low temperature UV curable coatings with selective gas permeability and excellent mechanical and optical transmission properties. By controlling the monomer amount ratios, the permeability of specific gases and the mechanical and transmission properties can be tailored to a specific application.

Prior to the present invention hydride functional silicones have long been prepared by batch processes wherein siloxane monomers are reacted by a hydrolysis reaction or by cationic polymerization to produce siloxane polymers and copolymers having a wide range of molecular weights. However, the hydrolysis reaction is difficult to control, and the resulting polymer typically contains, to some degree, hydroxyl substitution on silicon which causes undesired crosslinking, introduces haze, variability in properties and reduces the products shelf life.

There are two classes of catalysts available to carry out cationic polymerization reactions of cyclic siloxanes: homogeneous catalysts, such as sulfuric acid and trifluoromethane sulfonic acid, and heterogeneous catalysts, such as sulfuric acid supported on charcoal, acid clay, ion exchange resins, and acidic zeolites.

In the case of a homogeneous catalyst, it is necessary to inactivate the homogeneous catalyst after the polymerization reaction has reached a thermodynamic equilibrium, and to subsequently filter out salts formed prior to devolatilization. U.S. Pat. No. 5,554,708 of Biggs et al. teaches that trimethylsiloxy endcapped methylhydrogen polysiloxanes can be prepared by polymerization of hexamethyldisiloxane with pure methylhydrogen cyclic siloxane, in the presence of anhydrous trifluoromethane sulfonic acid catalyst. Once the polymerization reaction is complete, the trifluoromethane sulfonic acid catalyst is neutralized by adding sodium hydrogen carbonate. The polymer product is then subjected to filtration to remove salts and stripped of volatile components. However, in most cases catalyst residues and salts, following neutralization and filtration, remain in the polymer product which, at elevated temperatures during devolatilization, causes re-equilibration of silicone polymer back to the siloxane starting materials. However, elemental analysis of siloxanes catalyzed by acid ion exchange resins has shown the levels to be virtually non-detectable.

In U.S. Pat. No. 5,384,383 Legrow et al. disclose a process to produce pristine phenylpropylalkylsiloxanes, which contains no detectable methylhydrosiloxane. The process comprises hydrolyzing a phenylpropylalkyldichlorosilane followed by a batch equilibration in the presence of a heterogeneous acid catalyst. It is claimed that the reaction can be carried out in a continuous fashion with residence times of 3 to 5 minutes.

Buese et al. in U.S. Pat. No. 5,247,116 and Kostas in U.S. Pat. No. 5,491,249 disclose the use of packed bed reactors to carry out a redistribution reaction of polymethylhydrosiloxane in the presence of heterogeneous acid catalysts to produce cyclic siloxanes. The process is kinectically driven and conditions are varied to enhance the selectivity for a particular cyclic species.

However these patents do not disclose a continuous polymerization process to produce functional siloxane polymers and co-polymers which are the class of polymers of interest in this invention.

The large scale production of co-polymers by the above batch processes is cumbersome, expensive and generates excessive waste. It is subject to significant variations attributed to prolonged exposure of the methylhydrogen siloxane co-monomer, at elevated temperatures, to the catalyst; this can cause crosslinking and therefore an inconsistent product with batch to batch variations.

### BRIEF SUMMARY OF THE INVENTION

A primary objective of the present invention is to provide a continuous polymerization process of siloxane monomers which will eliminate batch to batch variations associated with the production of such polymers. Additionally, the ability to produce a uniform product on a continuous basis results in a process which is more efficient than those of the prior art.

Another objective of the present invention is to provide a process which has an increased rate of polymerization, reduced cycle time and enhanced efficiency, and thus improved process economics. This novel process results in a uniquely uniform polymeric product, which has properties that exhibit a remarkable degree of consistency and which ensures uniformity of performance unavailable to products made by prior art processes.

A further objective is to create a process which has a greater flexibility in producing co-polymers with a quick changeover time, reducing the waste generated between product changes and by recycling the catalyst. This, in turn, will improve the process economics and minimize waste generation.

The above and other objectives are achieved by a continuous polymerization process for producing liquid hydride-functional and/or organofunctional siloxane polymer products, which comprises the steps of: a). providing a substantially homogeneous liquid mixture of siloxane reactants; b). continuously introducing the siloxane reactants to a tubular reactor packed with a solid, acidic polymerization catalyst which is substantially insoluble in and substantially immobile to the siloxane reactants and the polymer products; c). driving the reactant mixture through the tubular reactor under substantially plug flow conditions; d). carrying out cationic polymerization of the siloxane reactants in the tubular reactor until reaching a substantially thermodynamic equilibrium composition of siloxane reactants and siloxane polymer products; e). continuously removing the substantially thermodynamic equilibrium composition from the tubular reactor; and f). volatilizing the siloxane reactants and any low boiling by-products from the equilibrium composition. The equilibrium composition contains substantially no catalyst or by-products, so that neutralization of the catalyst or filtering of the composition to remove catalyst, as is required in batch and homogeneous polymerization systems, is unnecessary.

Continuous systems are smaller than batch reactor systems, are less costly, contain less product, are easier to clean, generate less waste when cleaning is implemented between using the reactor system to make different products, and less material is lost from equipment holdup, so overall efficiency is higher. From an operating perspective, continuous systems are also more controllable, in the sense that the extent or degree of reaction is primarily determined by the reactor or equipment design, as opposed to elapsed time.

The continuous polymerization process of the present invention can be carried out under a wide range of process variables. The reaction temperature, residence time and pressure all depend on the molecular weight and viscosity of the polymer produced. The polymerization process of low molecular weight polymers can operate at higher temperatures and shorter residence times because of the more efficient heat and mass transfer, while higher molecular weight polymers are heat and mass transfer limited and require longer residence times and lower reaction temperatures in order to avoid crosslinking. The feed rate is determined by the residence time required for the polymerization to reach the thermodynamic equilibrium composition as well as the volume of the reactor.

The fast rate of polymerization attained in a catalytic tubular reactor allows for the use of smaller reactors than are used for conventional silicone polymer production processes, lower volumes of material to be in the continuous process at any given time, and fast changeover from production of a first material to production of a second material. Polymerizations of siloxane monomers catalyzed by a heterogeneous catalyst have enhanced thermal stability over silicones made by using conventional catalyst. This enhanced thermal stability is attributed to the absence of catalyst residues remaining in the product. Results from ICP analysis have shown catalyst residue to be below the detection limits of the instrument. The thermodynamic equilibrium composition of the polymer exiting the reactor is approximately 75-88% polymer, which is then devolatilized under reduced pressure.

The advantages of this continuous operation over previously used processes include product flexibility and enhanced efficiency and safety. The control of siloxane feed concentration, reactor residence time, and temperature afford great flexibility in tailoring the reaction conditions and therefore the range of products.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic flow diagram of one system for carrying out the process of this invention.

FIG. 2 is a graph illustrating the effect of catalyst amount on polymer conversion and pressure drop in a tubular reactor.

### DETAILED DESCRIPTION OF THE INVENTION

The present invention is a continuous, heterogeneous catalytic process which involves two phases; the catalyst which is a solid phase and the reactants and products which are a liquid phase. The heterogeneous catalyst is strongly acidic. The cationic polymerization of cyclic siloxanes when catalyzed by an acid starts by a ring opening polymerization and proceeds as a step-growth polymerization, i.e., initiation (ring scission), step growth, chain growth and termination. Such a polymerization will come to a thermodynamic equilibrium in a continuous monotonic approach. Equilibrium is established between open chain and ring structures because the cyclic siloxane monomers are as reactive as the growing silicone polymer. The thermodynamic equilibrium composition can be varied with temperature. Once the thermodynamic equilibrium composition for a specific reaction condition has been reached, the polymerization products exit the reactor.

The degree of polymerization and thus the molecular weight of the polymer are controlled by the addition of the appropriate amount of chain terminating agent. As the polymerization reaction proceeds, monomers add to the end of the polymeric chain forming longer and longer polymers. The terminating agent halts the polymerization reaction and thereby limits the degree of polymerization. For example, when hexamethyldisiloxane is used as the terminating agent, the diorganopolysiloxane polymer will terminate at each end with trimethylsiloxy groups. The choice of chain termination is made upon consideration of the end use of the polymeric product.

In a heterogeneous catalytic process, a heterogeneous catalytic reaction occurs at or very near the solid-liquid interface. For a catalytic reaction to occur, at least one and frequently all of the reactants must become attached to the surface. This attachment is known as adsorption and takes place by two different processes: physical adsorption and chemisorption. The type of adsorption that affects the rate of chemical reaction is chemisorption. A reaction is not catalyzed over the entire surface of the catalyst but only at certain active sites or centers. Presenting the catalyst in a solid form requires that the monomers be transported to a phase boundary (the surface of catalyst). Thus, the rate at which the process proceeds will be limited by transport, reaction rate, or a combination of both. By appropriate variation of flow rates, concentrations and temperature, the factors affecting the reaction rate can be optimized.

It should also be pointed out that heterogeneous catalysts do not maintain their activities at the same levels for indefinite periods. They are subject to deactivation and poisoning or fouling of the catalyst. Catalyst deactivation may be caused by aging phenomenon such as the deposit of foreign material on active portions of the catalyst surface.

In the present invention, for example, a mixture of monomer (dimethylcyclic siloxane); co-monomer (methylhydrogencyclic siloxane); and the chain terminating siloxane (hexamethyldisiloxane) is fed to a continuous, preferably isothermal, catalytic tubular reactor. The outlet composition of the reactor, which has reached thermodynamic equilibrium, is a polymethylhydrosiloxane-dimethylsiloxane copolymer, trimethylsiloxy terminated and cyclic siloxane monomers. The chemical reaction is described below:

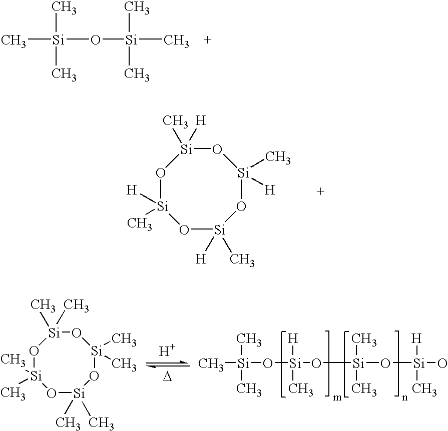

Several references in the literature have reported polymerization reaction data for polydimethylsiloxanes. Silicon-Based Polymer Science: A comprehensive resource, edited by J. Zeigler and F. Gordon Fearon; Chapter 3 (Formation of Linear Siloxane Polymers), by J. Saam, page 79, states that at high conversions the rate is first-order with respect to D₄ (octamethylcyclotetrasiloxane) and the order with respect to catalyst is 2.7 with either D₄ or D₆ (dodecamethylcyclosiloxane). Studies of the polymerization catalyzed by an acidic ion exchange resin at different temperatures reported the rate to be first order with respect to D₄ (M. Cazacu, et. al., Iranian Journal of Polymer Science and Technology, 3(1) (1994)). In another study in which the catalyst concentration (ion exchange resin) was examined, the rate is reported to be second-order with respect to D₄ and D₅ (decamethylcylopentasiloxane) and first-order with respect to catalyst (D. Hamann, et. al., Plaste Kaitschuk, 11, p. 603 (1979)). The discrepancy between orders with respect to D₄ can be attributed to the fact that Hamann, et. al. examined the polymerization beyond the equilibrium composition in which consecutive and reverse reactions play a significant role.

In the present invention it is assumed that the cationic co-polymerization of cyclic siloxane monomers is a reversible, homogeneous, liquid phase reaction which is first order with respect to siloxane monomer, zero order with respect to terminating agent and is non-elementary. Therefore the rate law is expressed as follows:

$$- {r}_{D}^{′} = {k}^{′} {C}_{D}$$

$${k}^{′} = {A}^{′} {e}^{- \frac{Ea}{RT}}$$

where

| Variables | Description | units |
|---|---|---|
| r_{D}: | rate of reaction, | mol/kg cst.s |
| k′: | specific reaction rate constant, | L/kg cat.s |
| C_{D}: | monomer concentration, | mol/L |
| A′: | frequency factor, | L/kg cat.s |
| Ea: | activation energy, | J/mol |
| R: | gas constant, | J/mol.K |
| T: | absolute temperature, | K |

It is assumed in the present kinetic model that methylhydrogen siloxane monomers have similar reactivity as dimethylcyclic siloxane monomers and are not differentiated in the kinetic model, i.e., the monomer concentration, C_{D}, is a combination of octamethylcyclotetrasiloxane, D₄, and tetramethylcyclotetrasiloxane, D′₄; C_{D} is a combination of both, —Si(CH₃)₂O— and —(CH₃)SiHO— units. From data provided in the above references, the frequency factor, A′, is 1036.8 L/kg cat.s and the activation energy is 32.4 kJ/mol. The terminating agent is present in a very low concentration and has not been found to be a rate limiting step in the polymerization reaction. Also, in liquid-phase reactions, the concentration of reactants is insignificantly affected by even relatively large changes in the total pressure. Consequently, the effect of pressure on the rate of reaction is ignored.

Also, when producing silicones polymers of high MW and thus high viscosity, the rheological properties of the polymer must be taken into account. Silicones are Newtonian fluids which, when subjected to high shear, display a rheological behavior termed as thixotropy, i.e., viscosity decreases (apparent viscosity) with time of deformation; the effect is temporary and viscosity goes back to its original value. Critical velocity gradients for various polydimethylsiloxanes are reported in Silicones Fluids: Stable, Inert Media, Gelest, Inc. (2002).

Suitable monomeric starting materials for the present invention are well known and commercially available. They have the general formula:

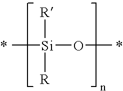

where R′ denotes hydrogen or an optionally substituted functional alkyl, alkyl, alkenyl, aryl, alkaryl or aralkyl group having 1 to 20 carbon atoms, R denotes a substituted alkyl, aryl, alkaryl or aralkyl group having 1 to 20 carbon atoms, and n denotes an integer with values of from 3 to 1000.

The functional alkyl groups can be, for example: chloropropyl, acryloxypropyl and methacryloxypropyl. The alkyl groups can be, for example: methyl, ethyl, n-propyl, trifluoropropyl, n-butyl, sec-butyl and t-butyl. The alkenyl groups can be, for example: vinyl, allyl, propenyl, and butenyl. The aryl, alkaryl and aralkyl groups can be, for example, phenyl, tolyl, benzyl and phenypropyl. The preferred groups are hydrogen, methyl, ethyl, phenyl, trifluoropropyl, acryloxyproply, methacryloxypropyl and vinyl. Preferably, the value of n is from 3-500, most preferably from 4 or 200.

Starting materials can be one or more of any of several cyclic siloxanes, for example: octamethylcyclotetrasiloxane, decamethylpentacyclosiloxane, tetra(phenylmethyl)cyclotetrasiloxane, tetramethylcyclotetrasiloxane, tetra(vinylmethyl)cyclotetrasiloxane and mixtures thereof. The choice of radicals will depend on the intended use of the end product.

Linear polysiloxane starting materials are also suitable for the practice of the present invention. Suitable polysiloxane starting materials include, for example: poly(dimethylsiloxanes), poly(methylhydrosiloxanes), poly(methylethylsiloxanes), poly(methylphenylsiloxanes), poly(phenylhydrosiloxanes), poly(diphenylsiloxanes), copolymers of dimethylsiloxane and methylhydrosiloxane, copolymers of methylphenylsiloxane and dimethylsiloxane and copolymers of diphenylsiloxane and dimethylsiloxane.

There is no theoretical upper limit to the molecular weight of the feed material, as long as the pressure drop generated across the reactor does not exceed the physical limitations of the reactor and it does not cause physical damage to the catalyst. Alternatively, high molecular weight polysiloxanes can be dissolved in a solvent before introducing them into the reactor. Such a solvent should have a boiling point above the operating conditions of the reactor, i.e., temperature and pressure. Solvents can be hydrocarbons and aromatic in nature; the preferred solvents are heptane and toluene.

A (chain) terminating agent or end capper is preferably used to regulate the degree of polymerization of the polymer and/or to add functionality. Suitable terminating agents have the general formula:

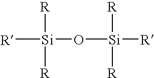

where R′ denotes hydrogen or an optionally substituted functional alkyl, alkyl, alkenyl, aryl, alkaryl or aralkyl group having 1 to 8 carbon atoms, R denotes substituted alkyl, aryl, alkaryl or aralkyl group having 1 to 8 carbon atoms.

In the terminating agent, the functional alkyl groups can be for example: aminopropyl, acryloxypropyl, methacryloxypropyl, and epoxypropyl. The alkyl groups can be, for example: methyl, ethyl, n-propyl, trifluoropropyl, n-butyl, sec-butyl and t-butyl. The alkenyl groups can be, for example: vinyl, allyl, propenyl, and butenyl. The aryl, alkaryl and aralkyl groups can be, for example: phenyl, tolyl, benzyl and phenethyl. The preferred groups are hydrogen, methyl, ethyl, phenyl, trifluoropropyl, acryloxyproply, metahcryloxypropyl and vinyl.

Various heterogeneous catalysts are known for the polymerization of siloxanes, However they must be compatible with the end product. Examples are acid clays, mineral acid catalyst, silica-alumina, titano-silica-alumina, acidic zeolites, sulfonated and trifluoromethane sulfonated ion exchange resins, such as Amberlyst® 15 made by the Rohm and Haas Company of Bristol Pa., Nafion® NR made by the Dupont Company of Wilmington, Del. and Dowex® DR-2030 made by The Dow Chemical Company. These ion exchange resins use styrene, divinylstyrene or perfluoroether supports for the catalysts.

The catalyst should preferably be in a form, such as pellets or beads, that can be packed into a reactor and allow the fluid to flow through the catalyst bed without carrying the catalyst with the fluid flow. Prior to loading the catalyst to the reactor, the catalyst should preferably be pretreated to remove contaminants and water absorbed by the catalyst particles. Catalyst pretreatment is strongly recommended, since the presence of water in the catalyst leads to undesired side reactions and typically reduces the rate of reaction. The catalysts of choice are the more economical, macroreticular polystyrene ion exchange resins, such as Amberlyst® 15 and Dowex® DR-2030, which are resistant to breakdown by osmotic and mechanical shock. Nafion® NR is the preferred catalyst for high throughput. The preferred catalyst for producing moderate volumes is Amberlyst® 15. It is a strongly acidic ion exchange resin used in heterogeneous acid catalysis. The resin has a macroreticular pore structure which permits access of liquid to the hydrogen ion sites which catalyze the reaction. It has a particle size of 0.35-1.18 mm with an average particle diameter of 0.5 mm, a surface area of 45 m²/g, an average pore diameter of 250 Å and a particle density of 1.264 kg/L. The maximum recommended operating temperature is 120° C.

The transport momentum, heat and mass, in these continuous reactors are important factors contributing to the design and operation. In the present invention, the polymerization reaction is carried out in a catalytic tubular reactor, i.e., packed bed reactor. A catalytic tubular reactor is a tubular reactor which is packed with solid catalyst particles. The advantage of the packed bed reactor is that for most reactions it gives the highest conversion per weight of catalyst of any catalytic reactor. The extent of reaction achieved does not depend on its shape, only on its volume. However, back mixing must be kept to a minimum; components must be fed at a constant rate to avoid composition variations over time. Deviations from ideal plug flow are due to back mixing within the reactor, the resulting product streams having a distribution of residence times. In extreme cases, back-mixing may result in the kinetic behavior of the reactor approximating that of the continuous stirred tank reactor (CSTR), and the consequent difficulty in achieving a high degree of conversion. These deviations are caused by channeling, where some substrate passes through the reactor more rapidly, and hold-up, which involves stagnant areas with negligible flow rate. Channels may form in the reactor due to excessive pressure drop, irregular packing or pulsing of the feed stream, causing flow rate differences across the bed.

It is important to realize that the flow of high viscosity material is characterized by very low Reynolds numbers (Re). Thus, there is essentially no turbulent transport mechanism or eddy activity to promote mixing or heat transfer. At low Re the flow rate is proportional to the pressure drop across the packed bed. This pressure drop, in turn, is generally found to be proportional to the flow rate and viscosity of the liquid phase, but inversely proportional to the cross-sectional area. The packed bed Reynolds number is defined as:

$${Re}_{p} = \frac{{D}_{p} {v}_{∞} ρ}{( 1 - φ ) η}$$

and the packed bed friction factor is defined as follows:

$${f}_{p} = \frac{{D}_{p} {φ}^{3}}{ρ {v}_{∞}^{2} ( 1 - φ )} \frac{\vert Δ P \vert}{L}$$

The Ergun equation used to determine the pressure drop in a packed bed is:

$${f}_{p} = \frac{150}{{Re}_{p}} + 1.75$$

Combining the above equations, the pressure drop in a packed bed is determined as follows:

$$\frac{ⅆ P}{ⅆ L} = - \frac{G}{ρ {g}_{c} {D}_{p}} ( \frac{1 - φ}{{φ}^{3}} ) [ \frac{150 ( 1 - φ ) η}{{D}_{p}} + 1.75 G ]$$

where:

| Variable | Description | SI Units |
|---|---|---|
| fₚ: | packed bed friction factor | |
| Dₚ: | particle diameter, | (m) |
| φ: | void fraction | |
| ρ: | liquid density, | (kg/m³) |
| ν_{∞}: | superficial velocity, | (m/s) |
| | ν_{∞} = ν₀/A_{c} | |
| \|ΔP\|: | pressure drop, | (Pa) |
| L, | packed bed length, | (m) |
| Reₚ: | Packed bed Reynolds | |
| | number | |
| η: | viscosity, | (Pa · s) |
| ν₀: | volumetric flow rate, | (m³/s) |
| A_{c}: | cross-sectional area of pipe, | (m) |
| g_{c}: | conversion factor, | (kg · m/s² · N) |
| G: | superficial mass velocity, | (kg/m² · s) |
| | G = ρν_{∞} | |

The second term can be neglected in the inertialess region, Reₚ≦10.

Excessive flow rates may distort compressible or physically weak particles. Particle deformation results in reduced catalytic surface area available for liquid phase contact, poor external mass transfer characteristics and restriction of flow, causing increased pressure drop. The use of uniformly sized catalyst particles in a reactor reduces the chance and severity of non-ideal behavior.

The most important characteristic of a catalytic tubular reactor is that, ideally, the fluid flows at the same velocity, parallel to the reactor axis and with no back mixing. In almost all situations involving flow in a packed bed, the amount of material transported by diffusion in the axial direction is negligible compared with that transported by convection (i.e. bulk flow). The longitudinal position within the reactor is, therefore, proportional to the time spent within the reactor. However, when a reactor is packed with catalyst, the reacting fluid usually does not flow through the reactor uniformly. Rather, there may be sections in the packed bed which offer little resistance to flow and, as a result, a major portion of the fluid may channel through this pathway. Consequently the molecules following this pathway do not spend as much time in the reactor as those flowing through the regions of high resistance to flow. There is a distribution of time that molecules spend in the reactor in contact with the catalyst.

In order to maintain the efficiency of the catalytic tubular reactor, it is necessary to maintain substantially plug-flow conditions. Plug flow means that the fluid monomer entering the packed bed will have a uniform residence time. The mean residence time, τ, is obtained by dividing the reactor volume, V, by the volumetric flow, νₒ, entering the reactor.

$$τ = \frac{V}{{v}_{o}}$$

This is the time necessary to process one reactor volume of fluid based on entrance conditions. During the polymerization reaction, a laminar flow regime is established due to the rapid polymerization reaction and thus a rapid increase in viscosity. In a laminar flow regime, a typical parabolic velocity profile of liquids flowing through pipes is established. That is, the liquid near the wall of the pipe would move at a lower velocity than the liquid in the center of the pipe, resulting in residence times varying according to radial position in the pipe. This variation of residence time would quickly result in the formation of a highly viscous polymer near the pipe wall moving at extremely low velocities and a stream of very low viscosity partly polymerized material flowing rapidly down the center of the pipe. Adverse effects of this situation are minimized through the packed catalyst bed because the fluid must flow around the catalyst particles creating a constant radial mixing. Thus, a substantially uniform velocity profile resulting in nearly constant residence times will be obtained. This is an idealized system where no back mixing takes place. Such a reactor allows plug-type flow, i.e., any portion of the reaction mixture entering the reactor receives essentially the same mean residence time therein as any other portion of the composition.

In practice, however, packed beds only approach plug flow. In order to take into account non-ideal flow situations, static mixers may be introduced to establish a uniform velocity profile and homogenize the fluid once it leaves the packed bed section. The volume and catalyst concentration in a packed bed reactor are fixed; therefore, the rate of polymerization will depend on the polymerization reaction temperature, selected within limits, which in turn will establish the rate of reaction and residence time required to reach the equilibrium composition with the desired degree of polymerization. The residence time will be such that the polymerization will take place over the entire packed bed length.

The polymerization process of the present invention is preferably carried out at a temperature in the range of about 15 to 180° C., and more preferably in a range of about 20 to 90° C. While the temperature may vary over the length of the tubular reactor, it is preferred that the reaction be carried out isothermally, since isothermal reaction helps to keep the reaction rates and viscosity gradients essentially constant.

The reactant mixture may have a residence time in the tubular reactor of about 1 to 480 minutes or more, but preferably about 15 to 60 minutes, and the reactor preferably operates at a pressure of about 5 to 600 psi.

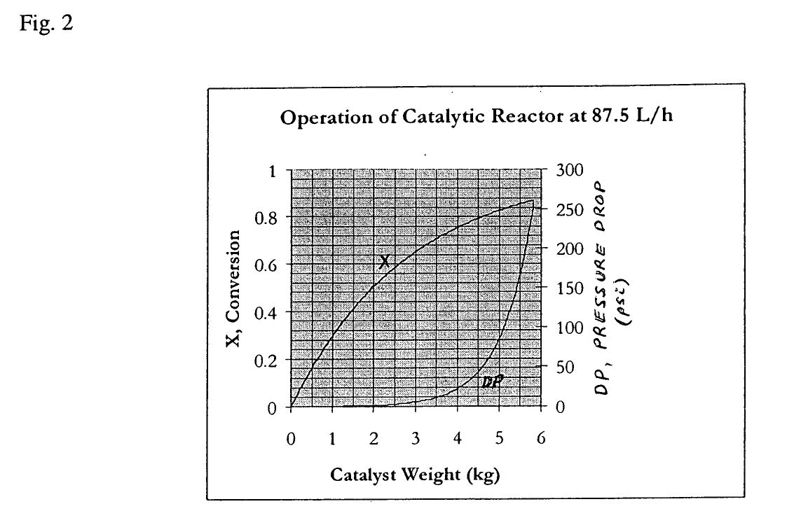

The residence time of the reactant mixture in the tubular reactor will depend upon the flow rate of the reactant mixture through the reactor, which in turn depends upon the reactor size or volume and the amount of catalyst used in the reactor. The flow rate and amount of catalyst used must be adjusted to optimize the conversion to the polymer product, as discussed in more detail below with reference to FIG. 2. Thus, if the flow rate is too low, there is a very high conversion at the beginning of the reactor, which results in a high viscosity of the reactant mixture (from conversion to polymer). This results in a high pressure build-up which may exceed the limits of the reactor. On the other hand, if the flow rate is too high, much of the reactant mixture is simply pumped past the catalyst, with a resulting low conversion rate to polymer.

Generally, it has been found desirable to achieve the highest viscosity of the reaction mixture at a point about 80% of the length of the reactor. In practice, it is usually necessary to make several plots from different trial runs, from which the pressure drop and degree of conversion can be calculated to achieve the best operating conditions. It will be understood by one skilled in the art that these conditions will vary depending upon the particular reactor used.

Initially, the development of a continuous cationic polymerization process of siloxanes was carried out in two types of catalytic reactors. The first reactor consists of a jacketed stainless steel schedule 40 pipe with a diameter of 7.62 cm and a length of 152.4 cm, thus having a length to diameter (L/D) ratio of 15. The monotube is packed with a heterogeneous catalyst and has holding plates at the ends to maintain the catalyst in place. The second reactor utilized in the development of the present invention is a static mixing reactor such as ones offered by Koch (SMR heat exchanger) and Schulzer. This type of reactor offers a high heat transfer capacity with single flow channel. The tube bundles are both mixing elements and active heat transfer surfaces. This reactor is ideal for plug-flow characteristics and isothermal operation, and the volume to heat transfer capacity is maintained on scale-up. The unit tested has a volume of 3.3 dm³ and a 78.5% void fraction. The L/D ratio is 4.

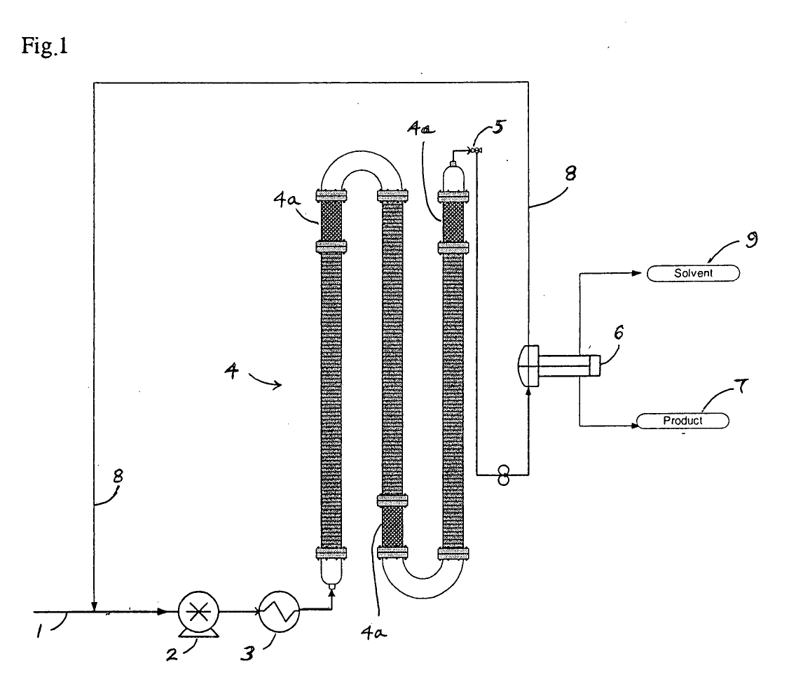

Once the feasibility of the process was established, a multipurpose, high throughput hybrid catalytic reactor, shown in FIG. 1, was designed and built to produce siloxane polymers and copolymers of various molecular weights. The hybrid reactor system is composed of three sections, the first of which may be used for heating and mixing of the reactants, or optionally may be packed with catalyst, and the last two are packed bed sections connected in series by 10.2 cm diameter Koch SMX static mixers, which are placed at the exits of the sections. Compact SMX modules (15 in. long) were introduced for homogenization of reactants and/or polymer exiting each section. The sections have a diameter of 10.2 cm and length of 152.4 cm.

The packed bed sections can be independently loaded with the appropriate catalyst weight according to the design parameters in order that the physical limitations of the process equipment are not exceeded. The starting process conditions are determined by the design equations for a catalytic reactor. The design equation for a continuous catalytic tubular (packed bed) reactor is:

$${F}_{D0} \frac{ⅆ X}{ⅆ W} = - {r}_{D}^{′} = {k}^{′} {C}_{D}$$

$${C}_{D} = {C}_{D0} ( 1 - X )$$

| Variable | Description | Units |
|---|---|---|
| F_{D0}: | initial molar feed rate of | (mol/s) |
| | monomer, F_{D0} = C_{D0}ν₀ | |
| X: | conversion of monomer | |
| W: | weight of catalyst, | (kg cat) |
| C_{D0}: | initial molar concentration of | (mol/L) |
| | monomer, | |
| ν₀: | inlet volumetric feed rate, | (L/s) |

Therefore the design equation can be expressed as:

$$\frac{ⅆ X}{ⅆ W} = α ( 1 - X ) \\ where \\ α = \frac{{A}^{′} {e}^{\frac{Ea}{RT}}}{{υ}_{0}} \qquad ( 1 )$$

The reactor volume and catalyst weight are related through the equation:

W=(1−φ)A_{c}Lρ_{c}

and combining this equation and the Ergun equation then

$$\frac{ⅆ P}{ⅆ W} = - \frac{G}{ρ {g}_{c} {D}_{p}} ( \frac{1}{{φ}^{3}} ) [ \frac{150 ( 1 - φ ) η}{{D}_{p}} ] \frac{1}{{A}_{c} {ρ}_{c}}$$

where ρ_{c} is the density of the solid catalyst particles (kg/m³). In calculating the pressure drop using the Ergun equation, the only parameter that varies with monomer conversion on the right hand side is the viscosity. The viscosity varies as function of siloxane concentration according to the following equation:

η=ΩC_{D}^{Ψ}

so that,

$$\frac{ⅆ P}{ⅆ W} = - {β ( 1 - X )}^{Ψ} \\ where \\ β = \frac{150 Ω G ( 1 - φ ) {C}_{D0}^{ Ψ}}{ρ {g}_{c} {D}_{p}^{2} {A}_{c} {ρ}_{c} {φ}^{3}} \qquad ( 2 )$$

In order to gain insight to the operating parameters, two coupled first order differential equations, (1) and (2), must be solved simultaneously. As an example of this invention, a trimethylsiloxy terminated polymethylhydrosiloxane-dimethylsiloxane copolymer having a molecular weight of 62,000 was produced. FIG. 2 shows how the conversion and reactor pressure vary as a function of catalyst weight.

As seen in the graph, the polymerization reaction at the specified flow rate and catalyst weight will reach the thermodynamic equilibrium composition within the equipment's design pressure of 2760 kPa. The design equations do not provide the optimum operating conditions for the process of this invention; they only provide an insight to the operating parameters which must be chosen within the physical limitations of the process equipment.

Polymer is produced in an isothermal catalytic tubular reactor at a rate within the physical limitations of the process equipment. The polymerization temperature ranges from approximately 15 to 180° C., preferably from 20 to 90° C. Prior to feeding the monomers to the reactor, they are degassed in order to remove any dissolved oxygen which may oxidize the methylhydrogen siloxanes and cause undesired crosslinking. The degassing also minimizes the formation of micro-bubbles and air pockets created during polymerization due to the small changes in density between monomers and polymer. A positive displacement pump feeds the monomer mixture at a constant adjustable rate. The pump discharge pressures can range from 35 to 2760 kPa. The feed mixture is then fed to the reactor through a heat exchanger in order to bring the monomers to the reactor's operating temperature, typically 20-90° C. A static mixer may also be used at the reactor inlet to insure a substantially homogeneous mixture of the siloxane reactants.

Once the polymer leaves the reactor, the polymerization reaction is stopped due to the absence of catalyst. Therefore, it is important that the polymerization reaction reach its equilibrium composition before exiting the reactor. The polymer exiting the reactor is then conveyed to a thin film evaporator wherein the polymer is devolatilized at 130 to 200° C. and reduced pressure to afford a homogeneous, optically clear silicone polymer having a volatile material content of typically 10 to 0.1% by weight. The volatilized fraction, containing unreacted or partially reacted siloxane reactants may be recycled to the reactor inlet.

In the following examples, the weight percent of polymer is given for the reaction product after devolatilization. The conditions needed for the devolatilization of polysiloxanes and the start-up conditions needed to attain steady state can easily be determined by one skilled in the art.

### Reactor Design Example

In a steady state operation, 87.5 L/h of a homogeneous mixture composed of 2.56 mol/L octamethylcyclotetrasiloxane, 3.7×10⁻³ mol/L polymethylhydrosiloxane fluid having a nominal structure of MD′₃₅M and 1.09×10⁻² mol/L hexamethyldisiloxane, was fed through pipe 1 to a heat exchanger 3 into the continuous catalytic tubular reactor unit 4 shown in FIG. 1, by a positive displacement pump 2 at a pressure of 2620 kPa. In this example the tubular reactor 4 consists of three jacketed 1.52 m long schedule 40 pipes connected in series by 15 in long Koch SMX static mixer modules 4a. The first of the three reactor sections in these example was not packed with catalyst, but was used for heating and mixing the reactants. The temperature was maintained at 60° C. The reaction mixture left the third reactor section through a Koch SMX static mixer with a temperature of 60° C. as a homogeneous optically clear fluid. The average residence time in the two packed sections together was 10.4 min and run time was 40 hours. The reaction product was conveyed through a back pressure regulating valve 5 at the thermodynamic equilibrium composition to a thin film evaporator 6 in which the product was devolatilized under reduced pressure. The product 7 is collected in a holding vessel, the volatile monomers 8 are recycled to the feed stream, and the solvent 9 is collected in vacuum traps. The copolymer product produced was an optically clear haze-free liquid affording a viscosity of 6.1 Pa's. No residual catalyst was detected in the product.

### EXAMPLES 1-11

The following tables list Examples 1-11 which illustrate the steady state operation of a continuous plug flow catalytic reactor to produce siloxane copolymers. Table 1 lists the materials used in these Examples, including the Gelest, Inc. product numbers and General Electric's siloxane notations. Table 2 lists the reactor types as well as their characteristics, catalyst type, catalyst weight and reaction volume. Table 3 lists the Examples' components designated by their abbreviations (from Table 1) as well as their respective feed concentrations. Table 4 lists for each Example the reactor type, steady state operating conditions, temperature, residence time, hours of operation and the composition of the exit stream as well as the products viscosity.

TABLE 1
List of Materials and abbreviations

| | Gelest | GE Siloxane | |
|---|---|---|---|
| Designation | Product Nos. | Notation | Generic Name |
| A | SIH6115.0 | MM | Hexamethyldisiloxane |
| B | SIO6700.0 | D₄ | Octamethylcyclotetrasiloxane |
| C | SID2650.0 | D₅ | Decamethylcylopentasiloxane |
| E | SIT7530.0 | D′₄ | 1,3,5,7- |
| | | | Tetramethylcyclotetrasiloxane |
| F | SIM6510.0 | D′₃-D′₅ | Mixed methylhydrogen |
| | | | cyclosiloxanes |
| G | HMS-991 | MD₂₄′M | Polymethylhydrosiloxanes |
| H | HMS-993 | MD₃₅′M | Polymethylhydrosiloxanes |
| I | SIT7546.0 | M′M′ | Tetramethyldisiloxane |

TABLE 2
Plug flow catalytic reactors type.

| | | | | | | Reaction |
|---|---|---|---|---|---|---|
| | | Length | Diameter | Catalyst | Catalyst | Volume |
| Reactor | Type | (m) | (m) | Type | Weight | (L) |
| 1 | Monotube | 1.52 | 0.102 | Amberlyst ® 15 | 1.2 | 7.1 |
| 2 | Koch-SMR | — | — | Amberlyst ® 15 | 3.0 | 1.6 |
| 3 | Monotube | 3.04 | 0.102 | Amberlyst ® 15 | 10.4 | 15.7 |
| | (two sections) | | | | | |

TABLE 3
Catalytic reactor's feed composition

| | | | | | | | | C_{D0}, Siloxane |
|---|---|---|---|---|---|---|---|---|
| | | Co- | Terminating | | | | SOLV | units |
| | Monomer | monomer | Agent | MOM | COM | TERM | (mole/L) | concentration |
| Example | (MOM) | (COM) | (TERM) | (mol/L) | (mol/L) | (mol/L) | (heptane) | (mol/L) |
| 1 | B | E | A | 1.8777 | 0.1332 | 0.0053 | 2.1708 | 8.0438 |
| 2 | B | G | A | 2.2083 | 0.1480 | 0.2699 | — | 12.6189 |
| 3 | C | G | A | 2.2083 | 0.1480 | 0.2699 | — | 12.6189 |
| 4 | B | G | A | 1.4120 | 0.2441 | 0.6832 | — | 11.8907 |
| 5 | C | G | A | 1.4120 | 0.2441 | 0.6832 | — | 11.8907 |
| 6 | B | H | A | 2.5584 | 0.0037 | 0.0109 | — | 12.9211 |
| 7 | B | H | A | 2.5584 | 0.0037 | 0.0109 | — | 12.9211 |
| 8 | C | H | A | 2.5584 | 0.0037 | 0.0109 | — | 12.9211 |
| 9 | C | G | A | 2.5584 | 0.0037 | 0.0109 | — | 12.9211 |
| 10 | C | G | A | 2.9287 | 0.0377 | 0.1219 | — | 12.6787 |
| 11 | C | — | I | 3.1885 | — | 0.2343 | — | 12.3563 |

TABLE 4
Catalytic Reactor's operating parameters and polymer properties

| | | Temper- | | Hours of | | |
|---|---|---|---|---|---|---|
| | Reactor | ature | τ | Operation | wt % | Viscosity |
| Example | Type | (° C.) | (min) | (hr) | Polymer | (Pa · s) |
| 1 | 2 | 60 | 50.7 | 18 | 75.0 | 10.0 |
| 2 | 1 | 25 | 28 | 92 | 89.5 | 0.035 |
| 3 | 2 | 60 | 25.4 | 53 | 78 | 0.035 |
| 4 | 1 | 25 | 22.5 | 11 | 89.5 | 0.010 |
| 5 | 2 | 60 | 25.4 | 53 | 78 | 0.010 |
| 6 | 1 | 60 | 75.0 | 141 | 89.5 | 8.0 |
| 7 | 2 | 60 | 34.56 | 144 | 85 | 7.0 |
| 8 | 3 | 60 | 47.1 | 142 | 88 | 6.1 |
| 9 | 3 | 60 | 28 | 60 | 88 | 0.120 |
| 10 | 1 | 60 | 22.5 | 10 | 89.5 | 0.125 |
| 11 | 2 | 90 | 25.4 | 12 | 89.7 | 0.09 |

### Comparative Example

A 50-gallon Pfaudler reactor (batch type) was charged with 150.29 kg of octamethylcyclotetrasiloxane, 1.328 kg of polymethylhydrosiloxane fluid having a nominal structure of MD′₃₅M, 0.287 kg of hexamethyldisiloxane and 7.6 kg of Amberlyst® 15 catalyst. The reaction mixture was heated at 60° C. for 72 hours, at which point the polymerization reaction reached the equilibrium composition. It was then allowed to cool to 30° C., and then the catalyst was removed by filtration. The reactor was cleaned of remaining catalyst particles and re-charged with 144.3 kg of the product and stripped to 150° C. under reduced pressure to yield 108.2 kg of trimethylsiloxy terminated polydimethylsiloxane-methylhydrosiloxane copolymer with a viscosity of 7.1 Pa's. Comparison of typical cycle times for the 50-gallon batch polymerization process (Pfaudler reactor) and a continuous process (Examples 6-8 above) are listed in the table below:

| | Batch, | Continuous, |
|---|---|---|
| | Time | Time |
| Process Step | (hr) | (hr) |
| Catalyst treatment prior | 8.0 | 8.0 |
| to reaction | | |
| Charge monomers to | 1.5 | 0.0 |
| reactor | | |
| Heat to reaction | 2.0 | 0.0 |
| temperature | | |
| Carry out reaction, | 72.0 | 36.2 |
| process time | | |
| Filter reactor contents | 8.0 | 0.0 |
| Cleanout reactor | 4.0 | 0.0 |
| Charge polymer to | 2.0 | 0.0 |
| reactor | | |
| Reduce pressure and heat | 2.0 | 0.0 |
| to temperature | | |
| Devolatize product | 5.0 | 72.3 |
| Empty and clean reactor | 4.0 | 0.0 |
| Total process time (hr): | 108.5 | 108.5 |
| Reactor Volume (L) | 189.3 | 37.2 |
| Catalyst weight (kg) | 7.6 | 5.75 |
| Product weight (kg) | 108.2 | 2692.4 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A continuous polymerization process for producing liquid hydride-functional and/or organofunctional siloxane polymer products, comprising the steps of:
(a). providing a substantially homogeneous liquid mixture of siloxane reactants;
(b). continuously introducing the siloxane reactants to a tubular reactor packed with a solid, acidic polymerization catalyst which is substantially insoluble in and substantially immobile to the siloxane reactants and the polymer products;
(c). driving the reactant mixture through the tubular reactor under substantially plug flow conditions;
(d). carrying out cationic polymerization of the siloxane reactants in the tubular reactor until reaching a substantially thermodynamic equilibrium composition of siloxane reactants and siloxane polymer products;
(e). continuously removing the substantially thermodynamic equilibrium composition from the tubular reactor; and
(f). volatilizing the siloxane reactants and any low boiling by-products from the equilibrium composition;
wherein the composition contains substantially no catalyst or by-products, such that neutralization of the catalyst or filtering of the composition is unnecessary.

2. The process according to claim 1, wherein the polymer products are selected from the group consisting of linear polymers, copolymers, terpolymers, and mixtures thereof.

3. The process according to claim 1, wherein the polymer products have a number average molecular weight in a range of about 500 to 200,000.

4. The process according to claim 1, wherein the polymerization step is carried out substantially isothermally.

5. The process according to claim 1, wherein the polymerization step is carried out at a temperature in a range of about 15 to 180° C.

6. The process according to claim 5, wherein the temperature is in a range about 20 to 90° C.

7. The process according to claim 1, wherein the reactant mixture has a residence time of about 1 to 480 minutes in the tubular reactor.

8. The process according to claim 7, wherein the residence time is about 15 to 60 minutes.

9. The process according to claim 1, wherein the tubular reactor operates at a pressure of about 5 to 600 psi.

10. The process according to claim 9, wherein the volatilized reactants and by-products are recycled to step (a).

11. The process according to claim 1, wherein the siloxane reactants comprise at least one siloxane monomer having the general formula: 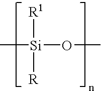
where R¹ is hydrogen or an optionally substituted functional alkyl, alkyl, alkenyl, aryl, alkaryl or aralkyl group having 1 to 20 carbon atoms;
R is a substituted alkyl, aryl, alkaryl or aralkyl group having 1 to 20 carbon atoms; and
n is an integer from 3 to 1000.

12. The process according to claim 11, wherein at least one of the siloxane reactants comprises a cyclic siloxane.

13. The process according to claim 11, wherein the siloxane reactants include at least one chain terminating agent.

14. The process according to claim 13, wherein the at least one chain terminating agent has the general formula: 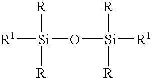
where R¹ is independently hydrogen or an optionally substituted functional alkyl, alkyl, alkenyl, aryl, aralkyl, or alkaryl group having 1 to 8 carbon atoms; and
R is independently a substituted alkyl, aryl, alkaryl, or aralkyl group having 1 to 8 carbon atoms.

15. The process according to claim 1, wherein the siloxane reactants comprise dimethylcyclic siloxane, methylhydrogencyclic siloxane and hexamethyldisiloxane, and the siloxane polymer product is poly-methylhydrogen siloxane-dimethylsiloxane copolymer, trimethylsiloxy terminated.

16. The process according to claim 1, wherein the siloxane reactants comprise linear polysiloxanes.

17. The process according to claim 16, wherein the reactant mixture includes a solvent for the polysiloxanes.

18. The process according to claim 1, wherein the catalyst is selected from the group consisting acid clays, mineral acid catalysts, silica-alumina, titano-silica-alumina, sulfonated ion exchange resins, acidic zeolites, and trifluoromethane sulfonated ion exchange resins.

19. The process according to claim 1, wherein step (a) is carried out by passing the siloxane reactants through a static mixer prior to entering the tubular reactor.

20. The process according to claim 1, wherein the equilibrium composition is removed from the tubular reactor through a static mixer.

21. The process according to claim 1, wherein the tubular reactor comprises two packed reactor sections.

22. A siloxane polymer product produced according to the process of claim 1 and being optically clear, homogeneous and substantially free of catalyst.

23. A trimethylsiloxy terminated poly-methylhydrogen siloxane-dimethylsiloxane copolymer produced by the process of claim 15 and being optically clear, homogeneous and substantially free of catalyst.
